(19) United States
(12) Patent Application Publication
(10) Pub. No.: US 2015/0350278 A1
(43) Pub. Date: Dec. 3, 2015

(54) SECURE STREAMING METHOD IN A NUMERICALLY CONTROLLED MANUFACTURING SYSTEM, AND A SECURE NUMERICALLY CONTROLLED MANUFACTURING SYSTEM

(71) Applicants: Kimmo ISBJÖRNSSUND, Tallinn (EE); Anton VEDESHIN, Tallinn (EE); FABULONIA OÜ, Tallinn (EE)

(72) Inventors: Kimmo Isbjörnssund, Tallinn (EE); Anton Vedeshin, Tallinn (EE)

(73) Assignee: Trondert OÜ, Tallinn (EE)

(21) Appl. No.: 14/761,588

(22) PCT Filed: Jan. 20, 2014
(86) PCT No.: PCT/EP2014/051065

§ 371 Date: Jul. 16, 2015

(30) Foreign Application Priority Data
Jan. 19, 2013 (EP) 13151981.1
Jun. 7, 2013 (EP) 13171159.0

(51) Int. Cl. H04L 29/06; B29C 67/00; G05B 19/4099

(52) U.S. Cl. CPC H04L 65/60; G05B 19/4099; B29C 67/0088; B33Y 50/02

(57) ABSTRACT

Secure streaming method in a numerically controlled manufacturing system, where the 3D file of the 3D object such as a CAD file or STL file is not sent to the manufacturing machine, but is kept in asecured system. Instead, only the instructions for controlling the manufacturing machine (e.g., so called G-codes) are streamed to the manufacturing machine. Such instructions are secured so that only a specific manufacturing machine can make use of them. To this end, the set of instructions may be encoded, e.g., hashed on a secure server, using a server hash table while the manufacturing machine is provided with a local lookup hash table that is synchronized, e.g., loosely synchronized with the serve's hash table for converting the hashed instructions back to instructions suitable for operating the manufacturing machine.

### TECHNICAL FIELD

The present invention relates to numerically controlled manufacturing systems, including rapid manufacturing and prototyping machines and systems, both by additive and subtractive methods, including 3D printing devices, with secure streaming of instructions for operating a manufacturing machine from a secure streaming server over a connection channel to a manufacturing machine, and more specifically, to methods and protocols used for streaming data in such systems.

### BACKGROUND ART

Rapid manufacturing and rapid prototyping are relatively new class of technologies that can automatically construct physical 3D objects from Computer-Aided Design (CAD) data. Usually these methods make use of additive manufacturing technologies such as 3D printers.

3D printing or additive manufacturing (AM) is a process of joining materials to make objects from 3D model data, usually layer upon layer, as opposed to subtractive manufacturing methodologies, such as traditional machining where the object is shaped by removing material. Several technologies are available for industrial uses, including for rapid prototyping and rapid manufacturing but increasingly so also for domestic and hobbyist uses. 3D printing is rapidly becoming as widespread as traditional 2D printing has become long ago.

Known is, e.g., WO2004/006087, disclosing a secure printing method in a traditional (2D) printing environment, where the print job as PDL print file such as PostScript file is encrypted with a cryptographic keys generated by the printer and then sent to the printer for decryption and printing the print job. While the method is useful to prohibit intercepting the print job by other devices in the network, this method does not avoid misuse of the print job by the printer itself and thus, leaves the owner of the rights of the document unprotected.

Combining 3D printing with 3D scanning makes possible 3D copying, i.e., a process where first a digital 3D model of an object is made by 3D scanning of the object and then a 3D copy of the 3D object is made by 3D reproducing the object similarly to the process of digital 2D copying.

It is well known that 2D printing and copying can be used to make copies of copyrighted materials or other materials protected by other types of intellectual property rights. While some technologies exist to inhibit copying, e.g., documents with security features such as watermarks, holograms, straps, UV or IR glowing, etc; however, no universally applicable technology exists to control reproducing and copying of copyrighted materials or other protected materials.

The problem becomes even more important in 3D printing and copying. For example, 3D objects can be subjects to different types of intellectual property rights independent from each other, including copyright (e.g., as sculptures, figurines, architectural objects, etc), industrial design (known in the US as design patent; e.g., a new shape of a product such as a vase or a chair), 3D trademark, by a patent (invention patent in the US) or a utility 3D model, or by personality rights (e.g., the likeness of a person). While certain fair use provisions may exist in copyright law (or analogous provisions for design patent or invention patent) allowing in some cases making copies for non-commercial private use, making copies of such 3D objects protected by intellectual property rights is prohibited at least for business purposes without a prior explicit permission (a license) from the right holder.

Known is U.S. Pat. No. 8,286,236 to Jung, titled Manufacturing control system, disclosing a method for secure manufacturing to control object production rights, such method comprises identifying at least one object data file configured to produce an object by a manufacturing machine; confirming that an authorization code is associated with the object data file, the authorization code configured to be received by the manufacturing machine, the manufacturing machine adapted to receive the authorization code; and enabling the manufacturing machine to interface with the object data file only if the authorization code meets one or more predetermined conditions, wherein the manufacturing machine is configured for at least one or more of additive manufacturing, subtractive manufacturing, extrusion manufacturing, melting manufacturing, solidification manufacturing, ejection manufacturing, die casting, or a stamping process. This approach is not secure enough as the 3D file can be freely copied and distributed and once the code is broken, the 3D file can be distributed without any control.

Known is WO2012/146943 to Within Technologies Ltd, titled Improvements for 3D design and manufacturing systems, disclosing a method of authenticating the printing of a three-dimensional (3D) article at a 3D printer according to an encrypted 3D print file describing a 3D design. The method comprises: receiving an authentication request from a 3D print server that is associated with the 3D printer, the request comprising a unique design identifier associated with a 3D design file and a unique 3D printer identifier associated with a 3D printer, the received unique 3D design identifier being related to the received 3D printer identifier in accordance with a first relationship; using at least one of the received unique identifiers to access a verifying 3D design identifier and a verifying 3D printer identifier, the verifying identifiers being related to each other in accordance with a second relationship; comparing the first and second relationships between the received and verifying identifiers; generating an authentication signal if the first relationship corresponds with the second relationship; obtaining a decryption key associated with the received identifiers in response to the authentication signal; and transferring the decryption key to the 3D print server to authenticate and enable the printing of the 3D article on the 3D printer. This solution may be considered as closest prior art.

Known methods are based on providing the 3D file with an authorization code or identifier for determining the authenticity of the 3D file. The use of the 3D file is controlled by the user right to access or print the 3D file. While these methods are suitable to inhibit unauthorized use of the 3D file itself, this approach is in fact misplaced as the object that is protected by copyright, design right or other intellectual property rights is not the file, but the 3D object itself While modifying the file can be perfectly legal, the prohibited activity is the unauthorized reproduction of the 3D object itself.

While it is important to allow users and manufacturers to determine if any restrictions exist on reproducing a 3D object, in preferred cases there must also be a mechanism in place to actually prevent the unauthorized reproduction of the 3D object. As the 3D file itself representing the 3D object according to this scenario does not necessarily have any means attached preventing unauthorized use of the 3D file, the known methods cannot be used. The authorization means must be integrated with the manufacturing device itself, e.g., before each manufacturing work, the manufacturing device needs an authorization from the rights holder, or confirmation that no restrictions exist.

The method similar to WO2012/146943 could be used, i.e., all the 3D files could be received from and sent through a service provider who modifies the 3D files by encrypting the file and providing it with identification codes. However, even though the 3D files that are transmitted in the system are encrypted, they can be copied, saved, intercepted and thus, misused, e.g., by breaking the code and after that making the 3D files available in the Internet or through file sharing solutions. Therefore, more secure system is needed.

What is needed, therefore, is a more secure method and system where the 3D model of a 3D object is safe from unauthorized use, but the 3D object can nevertheless be manufactured in a numerically controlled manufacturing system.

### SUMMARY OF INVENTION

The goal of the invention is achieved by a method and a system where the original 3D file of the 3D object such as a CAD file or STL file is not sent to the manufacturing machine, but is kept in a secured system and instead, only the instructions for controlling the manufacturing machine (e.g., so called G-codes) that are specific to this manufacturing machine are streamed to the manufacturing machine. Furthermore, such instructions are secured so that only a specific manufacturing machine can make use of them. Such manufacturing machine must be equipped with means for processing or converting said instructions into a format suitable for operating said manufacturing machine. To this end, the set of instructions may be encoded, e.g., hashed on a secure server, using a server hash table while the manufacturing machine is provided with a local lookup hash table that is synchronized, e.g., loosely synchronized with the server's hash table for converting the hashed instructions back to instructions suitable for operating the manufacturing machine. For example, time based or some common event or action based loose synchronization can be used.

According to one embodiment of the invention, a streaming method in a secure manufacturing system which comprises a streaming server and a numerically controlled manufacturing machine connected to said streaming server over a communication channel, the method comprises the steps of providing to the streaming server a model of a 3D object to be manufactured (hereinafter: 3D model) by said manufacturing machine, on said streaming server, converting said 3D model into a set of instructions for operating said manufacturing machine; encoding said set of instructions into a set of encoded instructions by applying simultaneously or in sequence one or more processes such as calculating a set of hashed instructions by applying a cryptographic hash function to said set of instructions, calculating a set of obfuscated instructions by applying obfuscation function to said set of instructions, applying arithmetic coding to said set of instructions, applying digital fingerprints, calculating checksums, calculating hash values, calculating digital DNA, and encrypting said set of instructions; and outputting said set of instructions to said manufacturing machine over said communication channel.

3D models secured streaming algorithm is using one way functions, i.e., functions that produce easy to compute strings for any given streaming block, but from these strings it is not possible to generate initial block. Also, it is impossible to modify the initial block without modifying said string. Moreover it is infeasible to find two different blocks which correspond to the same generated string. The cryptographic hash functions include such well known functions such as message digest algorithms (MD4, MD5), secure hash algorithms (SHA-1, SHA-2, SHA-3), Skein, Keccak, RadioGatun, PANAMA, and many others. The ideal cryptographic hash function has four main properties: it is easy to compute the hash value for any given message; it is infeasible to generate a message that has a given hash; it is infeasible to modify a message without changing the hash; it is infeasible to find two different messages with the same hash. Instead of cryptographic hash functions, non-cryptographic hash functions can be used as well as other one way functions having similar properties (i.e., easy to compute on every input, but hard to invert given the image of a random input) can be used for hashing. Even though general purpose hash functions can be used, also special purpose hash function can be designed, taking into account the nature of the data to be hashed (i.e., the instructions for controlling the manufacturing machine). Checksum functions, cyclic redundancy checks, checksums and fingerprinting functions can be used for hashing. Hashing can be performed using nonlinear table lookup.

According to another embodiment, on said streaming server a server hash table is generated; said set of instructions are hashed into a hashed set of instructions, using said server hash table; and the hashed set of instructions are outputted as a hashed stream of instructions to said manufacturing machine over said communication channel. On the manufacturing machine side, the hashed stream is received, a local hash table corresponding to and synchronized, e.g., loosely synchronized (e.g., time-based, action based) to said server hash table is calculated on said manufacturing machine, the hashed stream is converted to a stream of instructions, using said local hash table into and the converted stream of instructions is used to operate the operational part of the manufacturing machine.

According to one embodiment, the method comprises during said hashing periodically regenerating said hash table and correspondingly regenerating said local hash table during said converting said hashed stream according to a first predetermined precise time algorithm or other algorithm based on action or happening which are known to both the streaming server and a manufacturing machine independently, without actual sending or receiving information between each other.

According to one embodiment, the method additionally comprises splitting said set of instructions into split sets of instructions, obfuscating each of said split sets of instructions, hashing each of said obfuscated splits, streaming said hashed obfuscated splits independently over said communication channel from the streaming server to the manufacturing machine, converting said streamed splits into split sets of instructions and combining said split sets of instructions into the stream of instructions for controlling the manufacturing machine.

According to one embodiment, providing said 3D model comprises creating a secure connection over a communication channel between the streaming server and a source of 3D models, hashing said 3D model at the source of 3D models, transferring said hashed 3D model to said streaming server, before and re-hashing said hashed 3D model for streaming to said manufacturing machine.

According to one embodiment of the invention, the virtual machine is created and destroyed for each instance of streaming. Destroying of the virtual machine after the streaming is completed provides higher security as the server hash table cannot be recovered or reused.

According to one embodiment, the method additionally comprises destroying said virtual machine and creating new virtual machine instance so that each instance of streaming is carried out by more than one virtual machine.

According to one embodiment, the method additionally comprises creating more than one virtual machine for each instance of streaming, so that different parts of said 3D model are streamed by different virtual machines.

According to one embodiment, the system further comprises a computer device with a source of 3D models and the computer device is connected to said streaming server over a communication channel, and the method further comprises the steps of creating on said computer device a first virtual machine for providing said 3D model to said streaming server, hashing said 3D model in said first virtual machine, creating a secured virtual machine instance on said streaming server, receiving hashed 3D model by said secured virtual machine instance, storing said hashed 3D model in memory hash table, materializing said secured virtual machine instance into hashed virtual machine instance image, said image is transferred to a second computer device connected to a manufacturing machine, running said secured virtual machine instance on said second computer device and streaming locally said hashes of the 3D model to said manufacturing machine.

According to one embodiment, the secure manufacturing system comprises a plurality of streaming servers. Each streaming server is connected to the Internet and said steps of secure streaming are carried out by more than one streaming server in concert. Each of said streaming servers may be set up to stream a different part of said 3D model to be manufactured.

The goals of the invention are also achieved by a secure numerically controlled manufacturing system, the system comprising a streaming server, having a conversion module adapted for receiving a 3D model representing a 3D object to be manufactured and for converting said 3D model into a set of manufacturing instructions, an obfuscating and hashing module adapted to obfuscate and to hash said set of manufacturing instructions into a hashed set of instructions, a dynamic hash tables database adapted to provide hash tables for said hashing module and a precise time based pseudo number generator module; a source of 3D models, connected to said streaming server over a communication channel; and a manufacturing machine, connected to said streaming server over a communication channel, said manufacturing machine comprising an operational module, a hash lookup module for converting said hashed set of instructions, a Dynamic Local Hash Tables Database for providing hash tables for hash lookup module and precise time based pseudo number generator module for independently synchronizing the hash tables of the manufacturing machine with the hash tables used on said streaming server. The system may comprise a plurality of streaming servers, each of said streaming servers connected to the Internet and adapted perform said secure streaming in concert.

The system according to one embodiment comprises a 3D printer equipped with a secured module and having a connection to a Cloud; a Master Server located in the Cloud, said Master Server comprising a front-end application programming interface for Front End API F and an application programming interface for the back end API B. Marketplaces such as web stores providing 3D models are connected to the Master Server through the API F. 3D models can be uploaded to the system into a Secure Storage in the Cloud using back end through the API B.

The system is operated as follows. The 3D objects offered for reproduction are shown on the Marketplaces (preferably as 2D images, i.e., not the actual 3D model files). The user picks a specific 3D object to be reproduced, and indicates a specific 3D printer to be used (e.g., the one connected to her computer over USB port). Upon receiving a request from the user, the Master Server first checks the permission to reproduce the 3D object and then creates a Virtual Machine for securely streaming instructions necessary for reproducing the 3D object to the 3D printer. Such Virtual Machine is created only for streaming one specific 3D model and to only one specific 3D printer. The Virtual Machine (and only the Virtual Machine) can access the Secure Storage to access this specific 3D model. Only one specific 3D printer is associated with and can access one Virtual Machine. The 3D printer connects to the Virtual Machine as follows. When the 3D printer is connected to the network, it connects to the Master Server using personal certificate. Secure channel is then established between 3D printer and the Master Server when the 3D printer is plugged into the network.

When the Virtual Machine is created, the Master Server provides the Virtual Machine with an IP address and port number. The 3D printer is associated with the IP address and port and creates secure network with the Virtual Machine, using, e.g., Virtual Private Network (VPN). The connection is possible only if the personal certification matches the certificate on Virtual Machine.

The streaming protocol includes:

Authorization. Virtual Machine is checking from the Master Server whether the permission exists to print 3D model.

Network speed check (e.g., the Virtual Machine sends one file of sufficient size and determines the time spent, and the 3D printer sends another file); if the speed is good enough, the secure streaming can begin. Speed check can be repeated during the printing process; printing can be resumed in case of network interruptions.

Hashing a set of G-codes into one block, and sending the blocks. When the block is sent, the Virtual Machine communicates to the Master Server the status update.

After the 3D model is reproduced, the Virtual Machine is destroyed.

More than one Virtual Machines can be created for printing single 3D object for increased security. For example, first Virtual Machine is created and streams first portion of the 3D object. Then the first Virtual Machine is destroyed, the Second Virtual Machine is created and streams the second portion of the 3D object, and so on until the 3D object is finished. Then the last Virtual Machine is destroyed.

The invention is also the method as shown in FIG. 10.

### BRIEF DESCRIPTION OF DRAWINGS

FIG. 1 is a block diagram of exemplary system that supports the claimed subject matter of the present application.

FIG. 2 is a block diagram of one embodiment of the secure streaming server and stream processing module of the manufacturing machine.

FIG. 3 is a block diagram of a multimode streaming system.

FIG. 4 is a flow chart of a method according to one embodiment of the invention.

FIG. 5 is a flow chart of a method according to another embodiment of the invention.

FIG. 6 is a flow chart of a method according to another embodiment of the invention.

FIG. 7 is a block diagram explaining a method according to still another embodiment of the invention.

FIG. 8 is a block diagram of the system according to one embodiment of the invention.

FIG. 9 depicts a block diagram of a system according to one embodiment of the present invention.

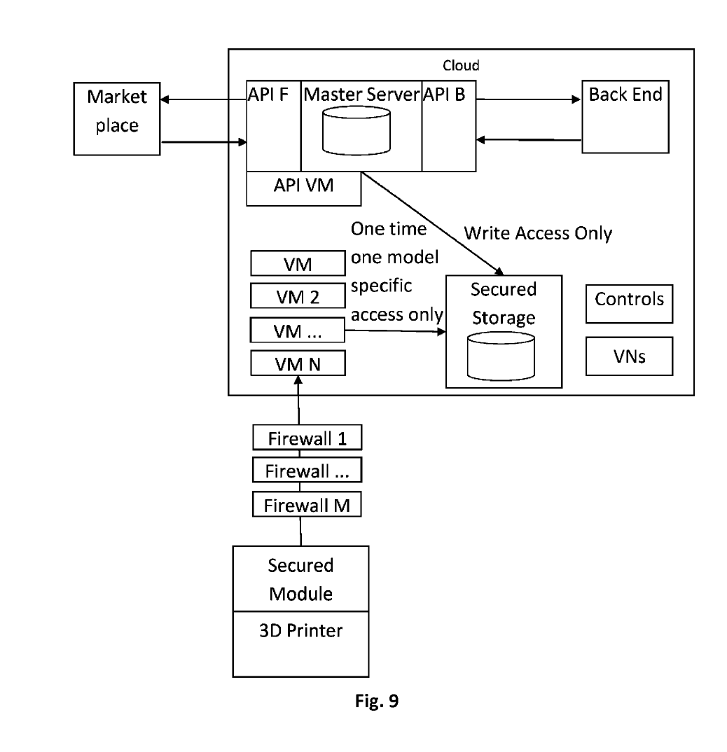

FIG. 10 depicts a flow diagram of a method according to one embodiment of the present invention.

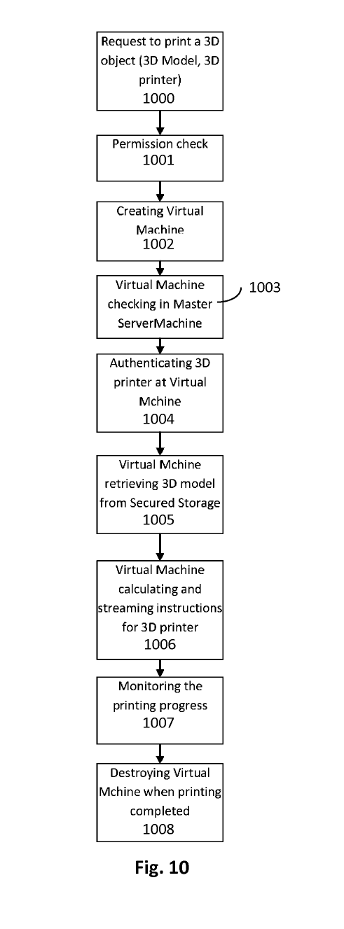

### DESCRIPTION OF EMBODIMENTS

Definitions

3D printer means any device suitable for making a three-dimensional solid object of virtually any shape from a 3D digital model.

3D printing means any numerically controlled automated manufacturing process. Cloud (or, a Computing Cloud) describes a variety of different computing concepts that involve a large number of computers that are connected through a real-time communication network (typically, the Internet).

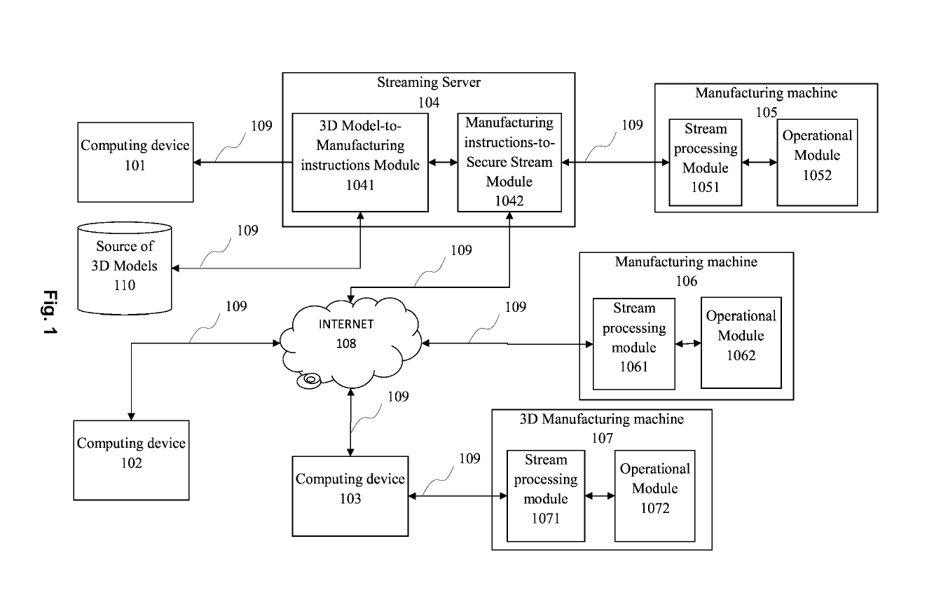

The block diagram of exemplary system that supports the claimed subject matter of this patent application is shown on FIG. 1. The system comprises one or more computing devices 101, 102 and 103 that are connected to Streaming Server 104 over a communication channel 109, including the Internet 108. The Streaming Server has one or more Manufacturing Machines 105, 106 and 107 such as 3D printers, etc, connected to it over a communication channel 109. The system also comprises a source of 3D models 110 for providing 3D models for the streaming server. The connection between the Streaming Server 104 and manufacturing machines is preferably over a secured channel, such as TLS and SSL for the Internet. The Streaming Server comprises a module 1041 for converting 3D models into a set of manufacturing instructions and a module 1042 for converting said set of instructions into a set of encoded instructions. The manufacturing machine comprises a module for stream processing (1051, 1061 and 1071, correspondingly) and an operational module (1052, 1062 and 1072, correspondingly) responsible for manufacturing the 3D object.

The 3D model here is any computer model of a 3D object to be manufactured, such as file(s) in any of the computer aided design (CAD) file format, STL file(s), or additive manufacturing file format. It can also be one or more files providing views of the 3D object in any image file format.

The manufacturing machine can be any numerically controlled manufacturing machine, such as three-dimensional additive manufacturing machines configured for rapid prototyping, three-dimensional printing, two-dimensional printing, freeform fabrication, solid freeform fabrication, and stereolithography. Manufacturing machines can also include a subtractive manufacturing machine, including machines adapted for drilling, milling, turning, laser cutting, waterjet cutting, plasma cutting, wire electrical discharge cutting, cold, warm and hot forging metal fabrication, computer numerical controlled fabrication machine, and/or an additive manufacturing machine, and/or an injection molding machine. The manufacturing machines further include an extrusion manufacturing machine, a melting manufacturing machine, a solidification manufacturing machine, an ejection manufacturing machine, a die casting manufacturing machine, a stamping process machine, an assembly robot assembling 3D objects from pieces or blocks.

The manufacturing machines can include a manufacturing machine configured to perform manufacturing using one or more of metal, wood, ice, stone, glass, nuclear materials, pharmaceuticals, edible substances, living substances, cells, chemical molecules, sand, ceramic materials, aluminium, silicon, carbides, silicon nitrides, silicon carbides, metal/ceramic combinations including aluminium/silicon nitride, aluminium/silicon carbide, aluminium/zirconium and aluminium/aluminium nitride including materials alterable by friction, heating and cooling.

The manufacturing instructions can be, e.g., G-codes or other instructions according to any computer language, including numerical control (CNC) programming language, but also high-level languages like python, java, PHP, etc. Such manufacturing instructions define where to move to, how fast to move, and through what path to move the operative part of the manufacturing machine, such as the printing head, the extruder head, etc, as well as other manufacturing parameters.

The communication channel can be provided by any technology used for numerically controlling manufacturing machines, e.g., any computer network using any communication media (i.e., wireless or wired), communication protocol (e.g., Internet Protocol, or Ethernet protocol, etc), or scale (e.g., near field network, personal network, local area network, wide area network. Also virtual private networks, peer to peer connections, or over satellite communication channels may be used.

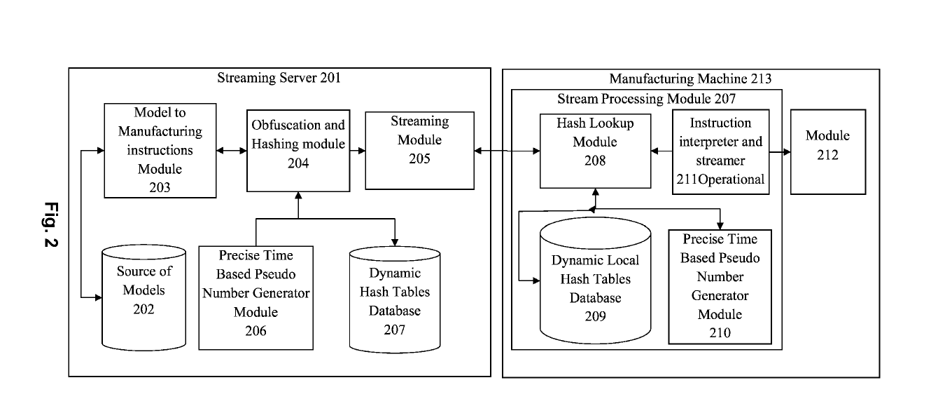

The block diagram shown on FIG. 2 further clarifies the architecture of the streaming server 201 according to one embodiment and corresponding manufacturing machine 213 comprising a Stream Receiving Module 207 and an Operational Module 212. The Streaming server 201 according to this embodiment comprises a Source of 3D models 202 for providing 3D models, a module 203 for converting 3D model to manufacturing instructions, a module 204 for obfuscating and hashing the manufacturing instructions into a hashed stream, and a Streaming Module 205 for outputting said hashed stream over a computer network to the manufacturing machine. The hashing is controlled by Precise Time Based Pseudo Number Generator Module and performed using a hash table provided by a Dynamic Hash Tables Database 207.

The stream processing module 207 comprises a Hash Lookup Module 208 for converting the hashed stream into stream of instructions. This converting is controlled by Precise Time Based Pseudo Number Generator Module 210 and performed using a Dynamic Local Hash Tables Database 209. The converted stream of instructions is sent to the operational module using instruction interpreter and streamer 211.

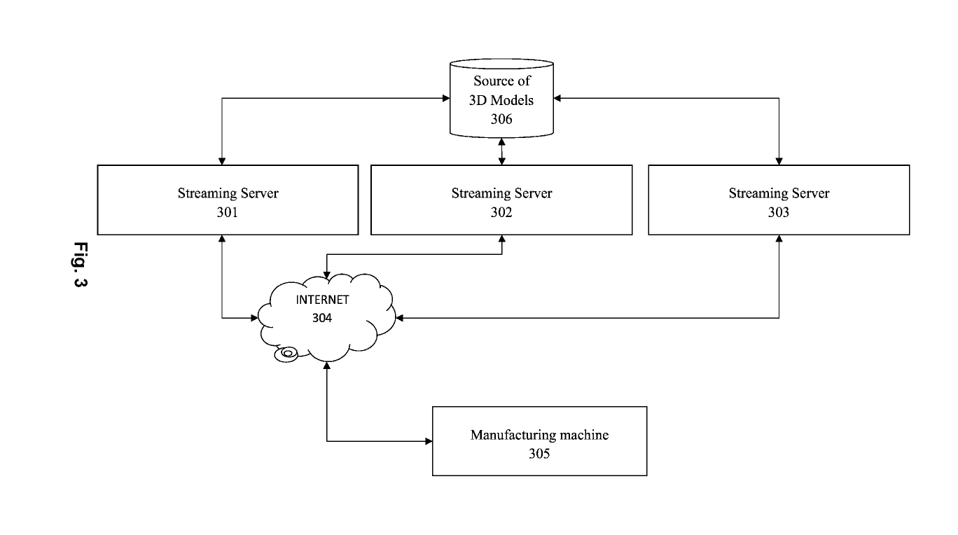

The block diagram of FIG. 3 shows a multimode streaming system, comprising several Secure 3D Object Streaming Servers (shown as 301, 302 and 303), connected to computer network such as Internet 304, a manufacturing machine 305, also connected to the computer network, and at least one source of 3D models 306 for providing 3D models to be streamed.

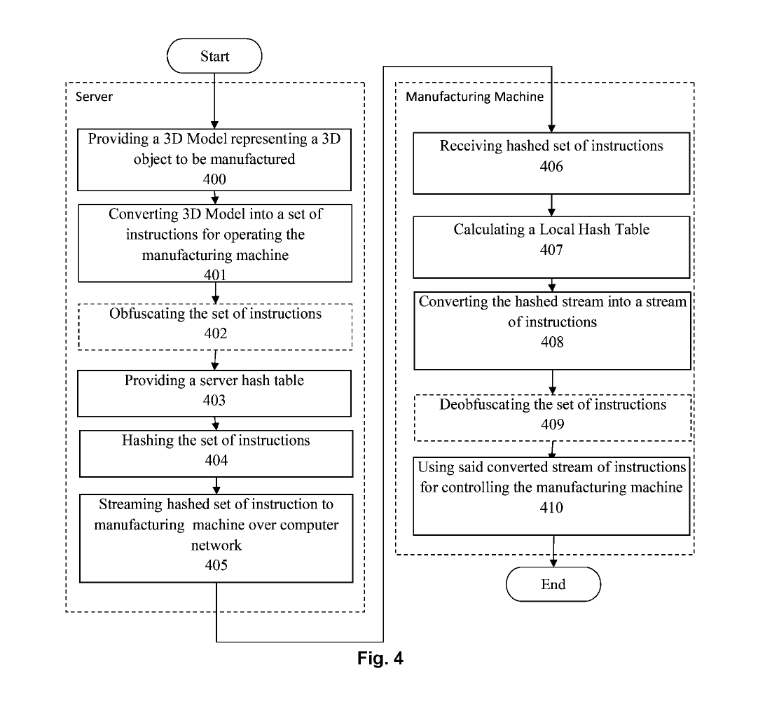

One embodiment of the secure streaming method is shown as a flowchart in FIG. 4. The secure streaming method comprises the steps of providing a 3D model representing a 3D object to be reproduced 400, converting said 3D model into a set of instructions, such as G-codes for operating the manufacturing machine 401, optionally obfuscating said set of instructions 402; providing a server hash table 403, hashing said set of instructions 404 and streaming said hashed set of instructions to manufacturing machine over a communication channel 405. On the manufacturing machine side, the method comprises the steps of receiving the hashed set of instructions 406, calculating on said manufacturing machine a Local Hash Table corresponding to and loosely synchronized to said server hash table 407, converting the hashed stream into a stream of instructions, using said Local Hash Table 408, deobfuscating the stream of instructions, if necessary 409 and using the converted stream of instructions for controlling the operational part of the manufacturing machine 410.

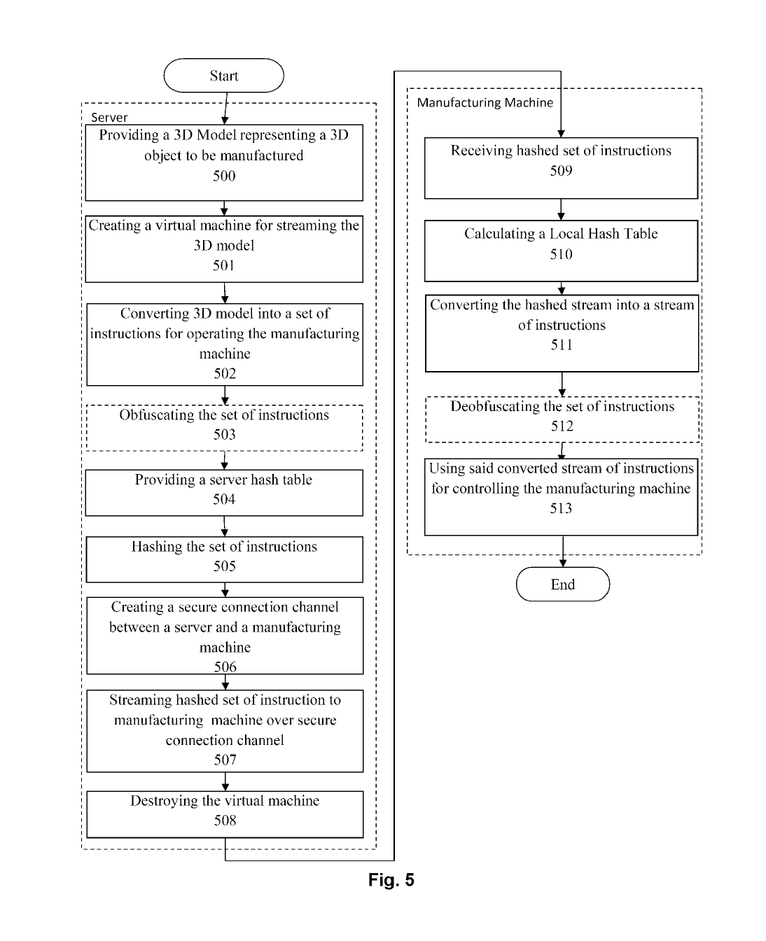

The flow diagram of FIG. 5 shows a modified embodiment of the invention. The secure streaming method comprises the steps of providing a 3D model representing a 3D object to be reproduced 500, creating a virtual machine for streaming the 3D model 501, converting said 3D model into a set of instructions, such as G-codes for operating the manufacturing machine 502, optionally obfuscating said set of instructions 503; providing a server hash table 504, hashing said set of instructions 505, creating a secure connection channel between a server and a manufacturing machine 506, streaming said hashed set of instruction to manufacturing machine over secure connection channel 507 and destroying the virtual machine 508. This approach makes it impossible to recover the hash table used for hashing from the server side as it is permanently destroyed together with the virtual machine. On the manufacturing machine side, the method comprises the steps of receiving the hashed set of instructions 509, calculating on said manufacturing machine a Local Hash Table corresponding to and loosely synchronized to said server hash table 510, converting the hashed stream into a stream of instructions, using said Local Hash Table 511, deobfuscating the stream of instructions, if necessary 512 and using the converted stream of instructions for controlling the operational part of the manufacturing machine 513.

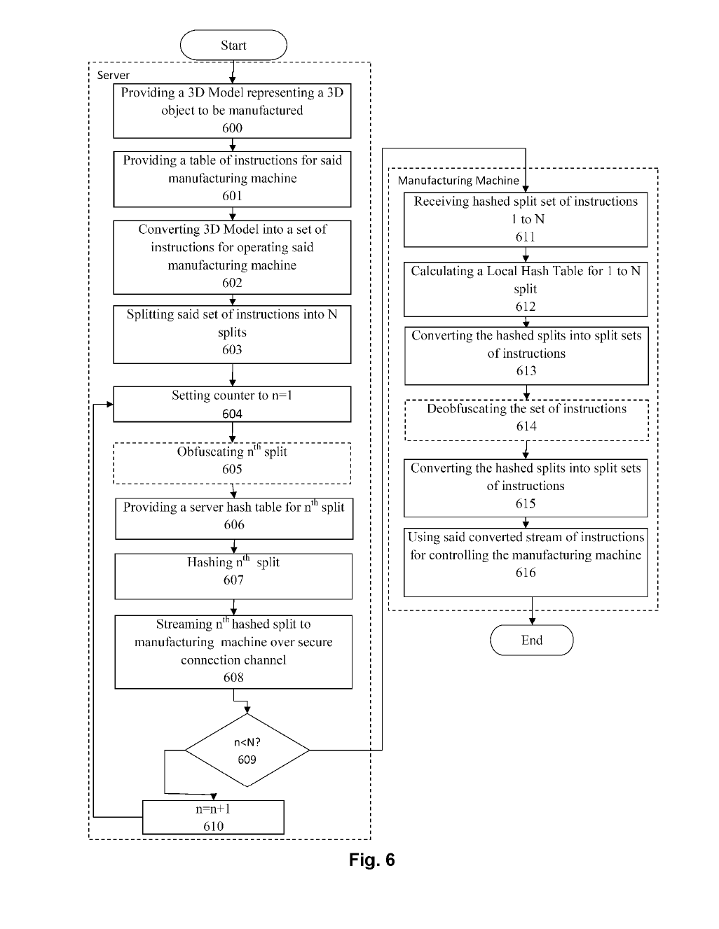

The flow diagram of FIG. 6 shows another modified method. The secure streaming method comprises providing a 3D model representing a 3D object to be reproduced by a manufacturing machine 600; providing a table of instructions for said manufacturing machine 601; converting 3D model into a set of instructions for operating said manufacturing machine 602; splitting said set of instructions into N splits 603, setting a counter to one 604; optionally obfuscating n^{th} split 605, providing a server hash table for n^{th} split 606; hashing n^{th} obfuscated split 607; streaming n^{th} hashed set of instructions to manufacturing machine over secure connection channel 608, checking if further splits exist 609, and if so, repeating steps 605 to 608 for n=(n+1)^{th} split 610. This method provides increased security as several hash tables are used for hashing the same stream. On the manufacturing machine side, the method comprises the steps of receiving hashed split sets of instructions 1 to N 611, calculating Local Hash Table for each 1 to N hashed split corresponding to and loosely synchronized to corresponding n^{th} server hash table 612, converting said streamed hashed splits into split sets of instructions 613, deobfuscating the split sets of instructions, if necessary 614, combining said split sets of instructions into the stream of instructions for controlling the manufacturing machine 615 and using the converted stream of instructions for controlling the operational part of the manufacturing machine 616.

Method as shown on FIG. 5 can be combined with the method as shown on FIG. 6, i.e., by creating a virtual machine for obfuscating, hashing and streaming each n^{th} split and destroying the virtual machine as soon as the streaming of the n^{th} split is completed.

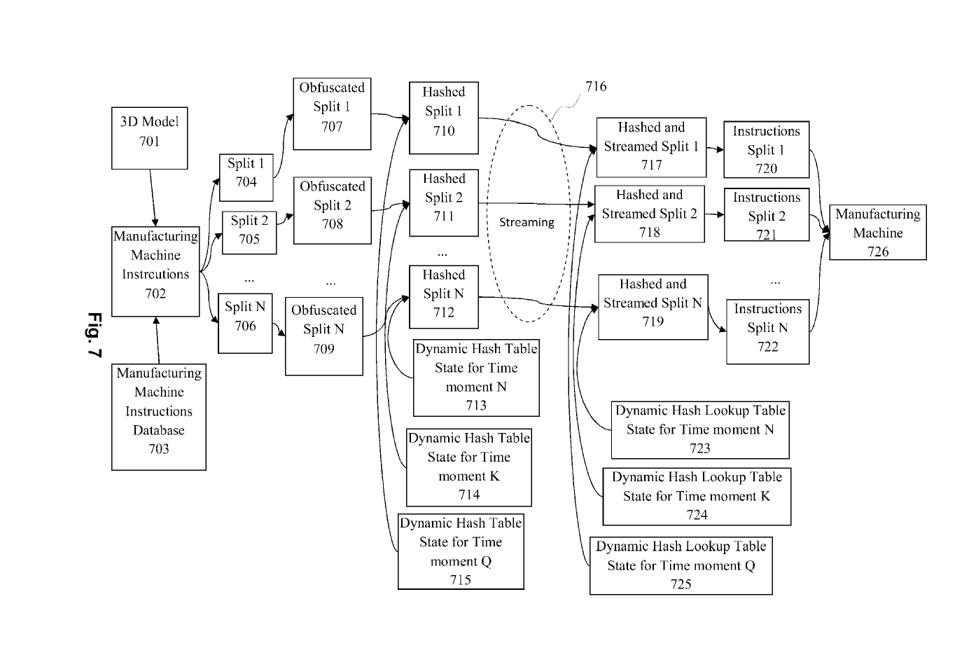

FIG. 7 shows a block diagram of another embodiment. 3D model 701 is provided. Manufacturing Machine Instructions 702 are calculated, using Manufacturing Machine Instructions Database 703. The instructions are split into N splits shown as 704 to 706. Then, the splits 704 to 706 are processed in parallel by first obfuscating the splits into obfuscated splits 707 to 709, then hashing each of said obfuscated splits into hashed splits 710 to 712, using a Dynamic Hash Table State for Time moment N 713, a Dynamic Hash Table State for Time moment K 714, and a Dynamic Hash Table State for Time moment Q 715 correspondingly. Each of the hashed splits 710 to 712 are then independently streamed over a network 716 Time moments N, Q and K may be unrelated to the specific split to be processed, so one dynamic hash table can be used to process more than one split, as well as more than one dynamic hash table can be used to process a single split.

At the receiving side, at the manufacturing machine, each of the hashed and streamed splits 717 to 719 are converted back to instructions splits 720 to 722, using a Dynamic Hash Lookup Table State for Time Moment N 723, a Dynamic Hash Lookup Table State for Time Moment N 724 and a Dynamic Hash Lookup Table State for Time Moment N 725 respectively, the splits are combined and outputted to the operational part of the Manufacturing Machine 726.

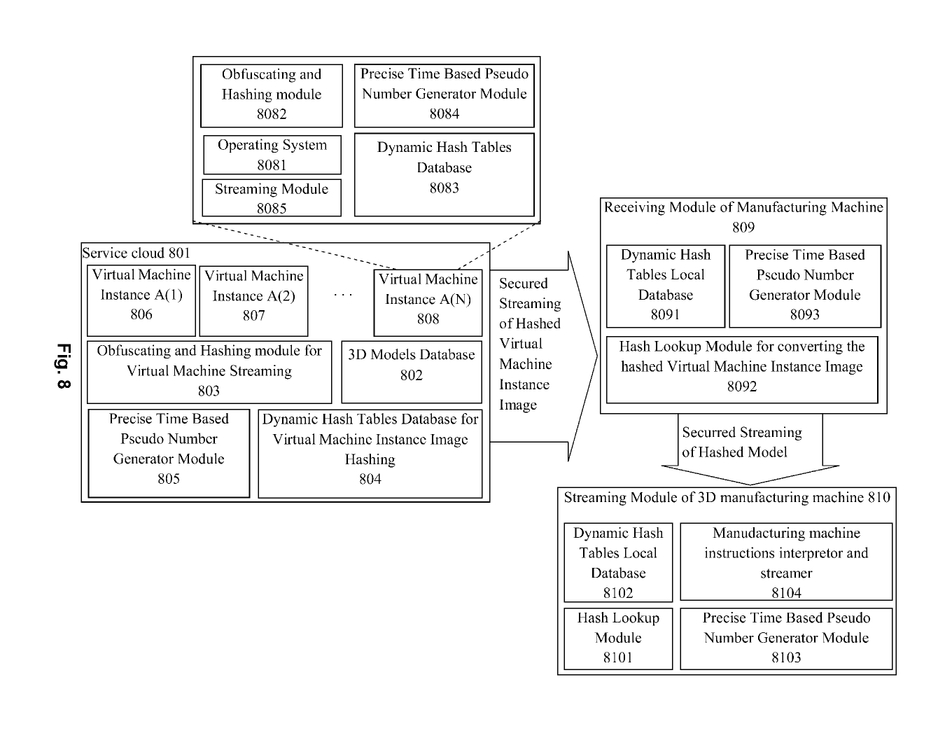

FIG. 8 shows another embodiment of the invention. The server is run in a service cloud. The server comprises 3D models Database 802, Obfuscating and Hashing Module for Virtual Machine Streaming 803, A Dynamic Hash Tables Database for Virtual Machine Instance Image Hashing 804 and a Precise Time Based Pseudo Number Generator Module 805. Several virtual machine Instances A(1) to A(N) (shown as 806 to 808) can be initiated at the server, each virtual machine instance comprising an operating system 8081, obfuscating and hashing module 8082, a dynamic hash tables database 8083, a precise time based pseudo number generator module 8084 and a streaming module 8085. The hashed virtual machine instance image is streamed to the receiving module of manufacturing machine 809, said module comprising a Dynamic Local Hash Tables Database 8091, Hash Lookup Module for converting the Hashed Virtual Machine Instance image 8092 and precise time based pseudo number generator module 8093. The hashed 3D model is then securely streamed to be converted to the stream of instructions principally as described above, using a Streaming module of the manufacturing machine 810, comprising a Hash Lookup Module 8101, a Dynamic Local Hash Tables Database 8102, precise time based pseudo number generator module 8103 and Manufacturing machine instructions interpreter and streamer 8104.

It is obvious for the skilled person that the different examples of the methods as described above can be freely combined. Similarly, the different examples of the systems as described can be freely combined. For example, instead of or in addition to hashing, other methods of encoding can be used, e.g. obfuscating the instructions, applying arithmetic coding to the instructions, or encrypting the instructions. Virtual Machines can be run in a cloud system. The streaming can be provided as a service in a cloud system. Each computing device connected to the network can be provided with software to run as a secure streaming server, so the designers can provide secure streaming of their 3D models for manufacturing. In a peer to peer system, each computing device connected to the peer to peer network can be programmed to act as a secure streaming server. Each computing device connected to the computer network, including the peer to peer network can be modified to act as a source of 3D models. Such computing device may be adapted to securely stream the 3D models to another secure streaming server for streaming to the manufacturing machine, or the source of 3D models can be integrated with secure streaming server to directly stream to the manufacturing machine.

The cryptographic hash functions include such well known functions such as message digest algorithms (MD4, MD5), secure hash algorithms (SHA-1, SHA-2, SHA-3), Skein, Keccak, RadioGatun, PANAMA, and many others. The ideal cryptographic hash function has four main properties: it is easy to compute the hash value for any given message; it is infeasible to generate a message that has a given hash; it is infeasible to modify a message without changing the hash; it is infeasible to find two different messages with the same hash. Instead of cryptographic hash functions, other one way functions having similar properties (i.e., easy to compute on every input, but hard to invert given the image of a random input) can be used for hashing. Even though general purpose hash functions can be used, also special purpose hash function can be designed, taking into account the nature of the data to be hashed (i.e., the instructions for controlling the manufacturing machine). Checksum functions, cyclic redundancy checks, checksums and fingerprinting functions can be used for hashing. Hashing can be performed using nonlinear table lookup.

The method and the system for secure streaming may be also useful in other fields of technology where secure streaming is required, e.g., 1. for streaming control commands for controlling objects from a distance, or 2. for streaming commands from one operating module to another module of a car, aircraft, ship, electronic or computing device, etc. 3. for media broadcasting (radio, television), 4. for broadcasting of 3D object from storage module to a presenting module of 3D device, like 3D projectors in 3D cinema, 3D TV, SMART TV, 3D gaming consoles, 3D mobile Apps, 3D virtual reality glasses, augmented reality applications and devices, 3D hologram devices and applications. It is immediately apparent for the skilled person that in this case, instead of instructions for controlling the manufacturing machine, different types of instructions, suitable for controlling such device need to be used.

While the method is based on streaming the instructions to the manufacturing machine, it could also include temporarily buffering or caching the stream in the manufacturing machine or on the server side before sending.

The system is shown on FIG. 1. In the Cloud, there is a Master server comprising:

An API F (Application programming interface for Front End), which is preferably a secured API (for example SSL, other kind), used by a Marketplace of 3D models. The secured streaming is initialized through the Marketplace.

An API B (Application programming interface for Back End), which is preferably a secured API (for example SSL, other kind), used by back end solutions of right holders to securely upload 3D models into a Secured Storage of 3D object models.

An API VM (Application programming interface on Virtual Machines), which is preferably a secured API for communication with the Secured Storage of 3D object models.

Virtual Machines, wherein every virtual machine VM 1 to VM N instance is executed for predetermined amount of time, for specific (i.e., one and only) 3D object model to be reproduced and for specific (i.e., one and only) 3D printer to be used for such reproduction. After the streaming session is completed, the Virtual Machine responsible for this streaming session is destroyed. Streaming session uses floating hashing tables to secure the streaming process; using hash tables for secure streaming is described in co-pending EP application No EP13151981.1.

An authorization table for 3D printers is kept on Master Server. Such table contains information on registered 3D printers, unique printer identifiers, permissions (e.g., license) start and end date, time of streamed 3D models, current state of the registered 3D printer (busy, available, not connected, network error, etc.), etc.

The Cloud also comprises a Secured storage of 3D files, where the 3D files and their parameters, as well as the meta information is stored. The Master Server can access the Secured Storage only for writing (Write Access Only). Only the correct Virtual Machine can access the Secured Storage for reading 3D files from the Secured Storage.

Different parts of the system in the Cloud (the Master Server, the Virtual Machines, the front end, the back end, the Secured Storage, the 3D printers, etc) are connected to each other in using secured connection, such as virtual networks, such as OpenVPN.

There is a proprietary protocol used by different parts of the cloud for communicating to each other. This protocol utilizes hashing and other encryption algorithms.

A 3D printer is connectable to the Master server. 3D printer could be any kind of 3D printer (USB connected, networked, WiFi printer, etc.). The printer communicates with the Cloud through a chip inside the 3D printer, a board inside the printer, or through a standalone device connected to the printer, or using computer software outside of the printer. Both 3D Printer internal parts, and external parts could be physically secured by a silicon/other material solid filling, or metal in-casing to make it rather impossible to disassemble, or when disassembled, the device will become non-operative.

3D printer is visible to a Cloud even if it is a behind a number of firewalls. 3D printer could have external IP address, but not necessarily. This is accomplished by so-called printer to server for virtual machine peer-to-peer virtual network.

The Master Server is adapted to run a number of detective checks which detect that if some suspicious activity happens in protocol, virtual network, cloud, master server, 3d printer, secure storage, virtual machine, etc., including ports scanning, excessive IP addresses in virtual network, wrong requests to API, behaviour inside protocol, alarm on every server (special commands and codes that should be executed in the first X seconds after connection to the server, port knocking before connection to the machines)

The secured 3D Printing Protocol used for secure streaming has the following parts:

Establishing a secured connection between the 3D printer and corresponding Virtual Machine, using two way SSL certificates;

Authorizing the 3D printer using personal certificates, unique identification number, etc.

Checking Network quality and speed (using, e.g., ping, upstream, downstream).

Sending blocks of hashed and preferably crypted g-codes, STL file chunks, etc.

Controlling the printing process (pause, stop, resume, status, temperature of extruders, etc.)

Checking the quality of the 3D printing, e.g., by providing video or photo stream of the printed model.

Marketplace could be any source of 3D models, e.g., 3D model web store, or other web based source of 3D models, such like Thingiverse, Shapeways, Cubify, GrabCad, Amazon, eBay, etc. Marketplace is a Front end solution that connects to the Master Server through the front end API F. For an end customer it is possible to initialize secured streaming of a 3D model from marketplace to a 3D printer of his choice, paying printing licence fee, choosing parameters for printing, initialize streaming of the model partially or at once to the 3D printer via a secured protocol. Moreover it is possible to distribute secured 3D models via email, facebook, twitter etc. This will lead to a web page (marketplace) with the possibility to buy and start streaming.

Back end is a system for management of 3D files by a right holder. Right holder can upload and protect 3D files, choose where they would like to publish these files for sales (e.g., on which Marketplaces), to assign descriptions, tags and keywords to files, choose number of prints allowed, set a price for every print, see a distribution statistics of 3d files, or to unpublish files from stores,

3D printers could be registered with the Master Server at the stage of manufacturing or during usage.

The Secured Storage resides on an encrypted segment of storage. This encrypted storage segment could be decrypted only by several human beings or any automation tool outside of the Master Server, so that if the server is physically stolen the database with 3D objects is not recoverable by a third party.

One example of the method according to present invention is depicted on FIG. 2. The method comprises the steps of receiving a request to print a 3D object (3D Model, 3D printer) 1000, checking permissions to print the 3D object at Master Server 1001, Creating a Virtual Machine for printing said 3D object 1002, said Virtual Machine checking in at said Master Server 1003, Authenticating said 3D printer at said Virtual Machine 1004, said Virtual Machine retrieving a 3D model from a Secured Storage 1005, said Virtual Machine calculating and streaming instructions for 3D printer 1006, said Virtual Machine Monitoring the printing progress 1007, Destroying the Virtual Machine when printing is completed 1008.

1. A streaming method in a secure manufacturing system comprising a streaming server and a numerically controlled manufacturing machine connected to said streaming server over a communication channel, the method comprises providing to the streaming server a 3D model of a 3D object to be manufactured by said manufacturing machine characterized in that the method additionally comprises on said streaming server, converting said 3D model into a set of manufacturing machine specific instructions for operating said manufacturing machine; encoding said set of instructions into a set of encoded instructions by applying simultaneously or in sequence at least one of the processes selected from the group consisting of calculating a set of hashed instructions by applying a cryptographic hash function to said set of instructions, calculating a set of obfuscated instructions by applying obfuscation function to said set of instructions, applying arithmetic coding to said set of instructions, applying digital fingerprints, calculating checksums, calculating hash values, calculating digital DNA, and encrypting said set of instructions; and
outputting said set of instructions to said manufacturing machine over said communication channel.

2. A method as in claim 1, comprising providing a server hash table on said streaming server; hashing said set of instructions into a hashed set of instructions, using said server hash table; and outputting said hashed set of instructions as a hashed stream of instructions to said manufacturing machine over said communication channel.

3. A method as in claim 2, comprising on the manufacturing machine receiving said hashed stream; calculating on said manufacturing machine a local hash table, corresponding to said server hash table; converting said hashed stream, using said local hash table into a stream of instructions and outputting said converted stream of instructions to operate the operational part of the manufacturing machine.

4. A method as in claim 2, comprising during said hashing repeatedly regenerating said hash table and correspondingly regenerating said local hash table during said converting said hashed stream according to a predetermined algorithm.

5. A method as in claim 1, comprising splitting said set of instructions into split sets of instructions, obfuscating each of said split sets of instructions, hashing each of said obfuscated splits, streaming said hashed obfuscated splits independently over said communication channel from the streaming server to the manufacturing machine, converting said streamed splits into split sets of instructions and combining said split sets of instructions into the stream of instructions for controlling the manufacturing machine.

6. A method as in claim 1, wherein said providing said 3D model comprises creating a secure connection over a communication channel between the streaming server and a source of 3D models, hashing said 3D model at the source of 3D models, transferring said hashed 3D model to said streaming server, and re-hashing said hashed 3D model for streaming to said manufacturing machine.

7. A method as in claim 1, creating a virtual machine on said streaming server for each instance of streaming said 3D model and destroying said virtual machine after said instance of streaming said 3D model is completed.

8. A method as in claim 7, comprising destroying said virtual machine and creating new virtual machine instance so that each instance of streaming is carried out by more than one virtual machine.

9. A method as in claim 7, comprising creating more than one virtual machine for each instance of streaming, so that different parts of said 3D model are streamed by different virtual machines.

10. A method as in claim 1, wherein the system comprises a computer device, comprising a source of 3D models, said computer device connected to said streaming server over a communication channel, the method comprising creating on said computer device a first virtual machine for providing said 3D model to said streaming server, hashing said 3D model in said first virtual machine, creating a secured virtual machine instance on said streaming server, receiving hashed 3D model by said secured virtual machine instance, storing said hashed 3D model in memory hash table, materializing said secured virtual machine instance into hashed virtual machine instance image, said image is transferred to a second computer device connected to a manufacturing machine, executing said secured virtual machine instance on said second computer device and streaming locally said hashes of the 3D model to said manufacturing machine.

11. A method as in claims 1, wherein said secure manufacturing system comprising a plurality of streaming servers, each streaming server connected to Internet and said steps of secure streaming are carried out by more than one streaming server in concert.

12. A method as in claim 11, comprising each of said streaming servers streaming a different part of said 3D model to be manufactured.

13. A secure numerically controlled manufacturing system, comprising a streaming server; comprising a conversion module adapted for receiving a 3D model representing a 3D object to be manufactured and converting said 3D model into a set of manufacturing instructions, an obfuscating and hashing module adapted to obfuscate and to hash said set of manufacturing instructions into a hashed set of instructions, a dynamic hash tables database adapted to provide hash tables for said hashing module and a precise time based pseudo number generator module; a source of 3D models, connected to said streaming server over a communication channel; and a manufacturing machine, connected to said streaming server over a communication channel, said manufacturing machine comprising an operational module, a hash lookup module for converting said hashed set of instructions, a Dynamic Local Hash Tables Database for providing hash tables for hash lookup module and precise time based pseudo number generator module for independently synchronizing the hash tables of the manufacturing machine with the hash tables used on said streaming server.

14. A system as in claim 13, comprising a plurality of streaming servers, each of said streaming servers connected to Internet and adapted perform said secure streaming in concert.

15. A system for secure 3D printing, comprising a 3D printer, comprising a secured module, and connected to a Cloud over said secure module; a Master Server located in the Cloud, said Master Server comprising a front-end application programming interface for Front End API F and an application programming interface for the back end API B, wherein at least one Marketplace for providing 3D models is connected to the Master Server with through the API F, the system further comprising a Secure Storage for 3D models, wherein said 3D models can be uploaded into a Secure Storage in the Cloud using back end through the API B, wherein the Master Server is adapted to receiving a request to print a 3D object, checking permissions to print the 3D object at Master Server, creating a Virtual Machine for printing said 3D object, said Virtual Machine is adapted for checking in at said Master Server, authenticating said 3D printer at said Virtual Machine, said Virtual Machine adapted for retrieving a 3D model from a Secured Storage, said Virtual Machine adapted for calculating and streaming instructions for 3D printer, said Virtual Machine adapted for monitoring the printing progress, and destroying the Virtual Machine when printing is completed.

16. A method of secure streaming for 3D printing, the method comprises the steps of receiving a request to print a 3D object, checking permissions to print the 3D object at Master Server, creating a Virtual Machine for printing said 3D object, said Virtual Machine checking in at said Master Server, authenticating said 3D printer at said Virtual Machine, said Virtual Machine retrieving a 3D model from a Secured Storage, said Virtual Machine calculating and streaming instructions for 3D printer, said Virtual Machine Monitoring the printing progress, and destroying the Virtual Machine when printing is completed.
